(19) United States
(12) Patent Application Publication
(10) Pub. No.: US 2026/0132661 A1
(43) Pub. Date: May 14, 2026

(54) REINFORCEMENT DEVICE AND CAR DOOR HANDLE ASSEMBLY INCLUDING THE SAME

(71) Applicant: HUSHAN AUTOPARTS INC., New Taipei City (TW)

(72) Inventors: Ying-Chih Chen, New Taipei City (TW); Ching-Chiang Tsai, Taipei City (TW); Chang-Sheng Su, Keelung City (TW)

(73) Assignee: HUSHAN AUTOPARTS INC., New Taipei City (TW)

(21) Appl. No.: 18/947,164

(22) Filed: Nov. 14, 2024

(51) Int. Cl. E05B 85/12; B60J 5/04

(52) U.S. Cl. CPC E05B 85/12; B60J 5/0423

(57) ABSTRACT

A reinforcement device is disclosed. The reinforcement device is able to be attached to a car door handle so as to form a car door handle assembly. The reinforcement device comprises a L-shaped cover member and an inner plater, wherein the L-shaped cover member consists of a first plate and a second plate. Specifically, the first plate covers one end side of the car door handle, the second plate covers one surface of the car door handle, and the inner plate is disposed between the first plate and the end side. Therefore, in case of the end side and the surface of the car door handle being covered by the reinforcement device, an impact of an external force applied onto the car door handle can be buffered by the reinforcement device, such that a service life of the car door handle is hence prolonged.

### BACKGROUND OF THE INVENTION

### 1. Field of the Invention

The present invention relates to the technology field of car door handles, and more particularly, to a reinforcement device and car door handle assembly including the same.

### 2. Description of the Prior Art

Car owners and/or drivers certainly know that, car door handle should have cracks and/or damages after long-term use or being subject to one or more times of impacts. In such case, the best solution for the car owner is to replace the car door having the damaged car door handle by a new one. However, experienced car owners have known that such a solution is time-consuming and costly.

Therefore, above descriptions have expressed that there is still room for improvement in the conventional car door handle. In view of that, inventors of the present invention have made great efforts to make inventive research and eventually provided a reinforcement device and car door handle assembly including the same.

### SUMMARY OF THE INVENTION

The primary objective of the present invention is to disclose a reinforcement device for being integrated in a car door handle, so as to cover one end side and one surface of the car door handle. Specifically, the reinforcement device according to the present invention includes following merits:
(1) reducing impact forces applied to the car door handle, thereby making the car door handle last longer;
(2) easy to be attached to the car door handle without needing to change the structure and/or constitutes of the car door handle; and
(3) not lead a negative effect to the appearance of the car door handle.

In order to achieve the aforementioned objective, one embodiment of the reinforcement device is provided, which is applied being attached to a car door handle, and comprises:
a L-shaped cover member, comprising:
a first plate for covering one end side of the car door handle; and
a second plate for covering one surface of the car door handle, being in connection with the first plate; and
an inner plate for covering the end side of the car door handle, being connected between the first plate and the end side of the car door handle.

In one embodiment, the surface of the car door handle has a recess structure, and the second plate is formed with a recess thereon, such that the recess is mated with the recess structure in case of the second plate covering the surface of the car door handle.

In one embodiment, an inner surface of the first plate is formed with a shallow recess thereon, and the inner plate connected between the first plate and the end side of the car door handle is received by the shallow recess.

In one embodiment, the first plate has a first bending portion, and the second plate is connected to the first bending portion.

In one embodiment, the inner plate is a metal plate, and has a second bending portion mating with the first bending portion.

In one embodiment, the surface of the car door handle has a first curvature, and the second plate has a second curvature that approaches or is equal to the first curvature.

In one embodiment, the end side of the car door handle is formed with at least one first screw hole thereon, the inner plate has at least one second screw hole corresponding to the at least one first screw hole, and the first plate has at least one third screw hole corresponding to the at least one second screw hole.

In one embodiment, the recess structure has first short side, a long side in connection with the first short side, and a second short side in connection with the long side, the first short side is provided with at least one fourth screw hole thereon, and a fifth screw hole is formed on the second short side.

In one embodiment, the recess is provided with at least one sixth screw hole and at least one seventh screw hole thereon, the at least one sixth screw hole is in correspondence with the at least one fourth screw hole, and the at least one seventh screw hole is corresponding to the at least one fifth screw hole.

In one embodiment, a protrusion block and two limit blocks are formed in the shallow recess, and the protrusion block is disposed between the two blocks.

In one embodiment, at least one ferrule is formed on the recess, and the ferrule has a bottom opening.

In one embodiment, the reinforcement device further comprises a bottom plate, and wherein:
a propping block is formed along a first side of the bottom plate, and has a convex portion;
at least one connection column is formed on a second side of the bottom plate;
the bottom plate is connected to the L-shaped cover member, and is limited between the two limit blocks;
after the bottom plate is connected to the L-shaped cover member, the propping block sustains a lower end side of the inner plate, and the at least one connection column received by the at least one ferrule; and
in case of the bottom plate being limited between the two limit blocks, the convex portion of the propping block is propped by the protrusion block.

In one embodiment, the ferrule is formed with an eighth screw hole therein, and a ninth screw hole is provided in the connection column for being in correspondence with the eighth screw hole.

In one embodiment, the reinforcement device further comprises:
at least one first screw for being screwed into the at least one third screw hole, the at least one second screw hole and the at least one first screw hole in turns;
at least one second screw for being screwed into the at least one sixth screw hole and the at least one fourth screw hole in turns;
at least one third screw for being screwed into the at least one seventh screw hole and the at least one fifth screw hole in turns; and
at least one fourth screw for being screwed into the at least one eighth screw hole and the at least one ninth screw hole in turns.

In addition, one embodiment of a car door handle assembly, which comprises a car door handle and one aforesaid reinforcement device according to the present invention, wherein said reinforcement device is attached to the car door handle, so as to cover one surface and one end side of the car door handle.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1A shows a first stereo diagram of a car door handle assembly according to the present invention.

FIG. 1B shows a second stereo diagram of the car door handle assembly according to the present invention.

FIG. 2A shows a first exploded diagram of a reinforcement device according to the present invention.

FIG. 2B shows a second exploded diagram of the reinforcement device according to the present invention.

FIG. 3A shows a third exploded diagram of the reinforcement device according to the present invention.

FIG. 3B shows a furth exploded diagram of the reinforcement device according to the present invention.

FIG. 3C shows a fifth exploded diagram of the reinforcement device according to the present invention.

FIG. 4A shows a sixth exploded diagram of the reinforcement device according to the present invention.

FIG. 4B shows a seventh exploded diagram of the reinforcement device according to the present invention.

FIG. 4C shows an eighth exploded diagram of the reinforcement device according to the present invention.

### DETAILED DESCRIPTION OF THE PREFERRED EMBODIMENTS

To more clearly describe a reinforcement device and a car door handle assembly including the reinforcement device according to the present invention, embodiments of the present invention will be described in detail with reference to the attached drawings hereinafter.

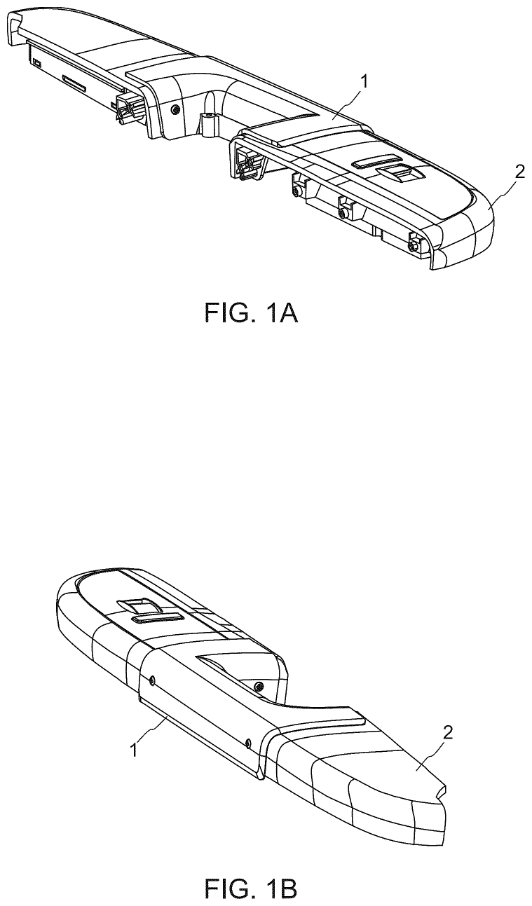

With reference to FIG. 1A and FIG. 1B, there are shown a first stereo diagram and a second stereo diagram of a car door handle assembly according to the present invention. As FIG. 1A and FIG. 1B shows, the car door handle assembly comprises a car door handle 2 and a reinforcement device 1. Specifically, the reinforcement device 1 is attached to the car door handle 2, so as to cover one surface and one end side of the car door handle 2.

### First Embodiment

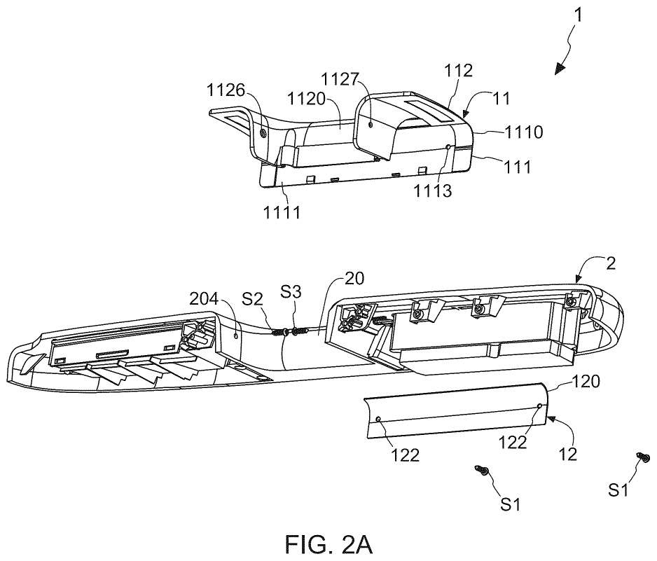

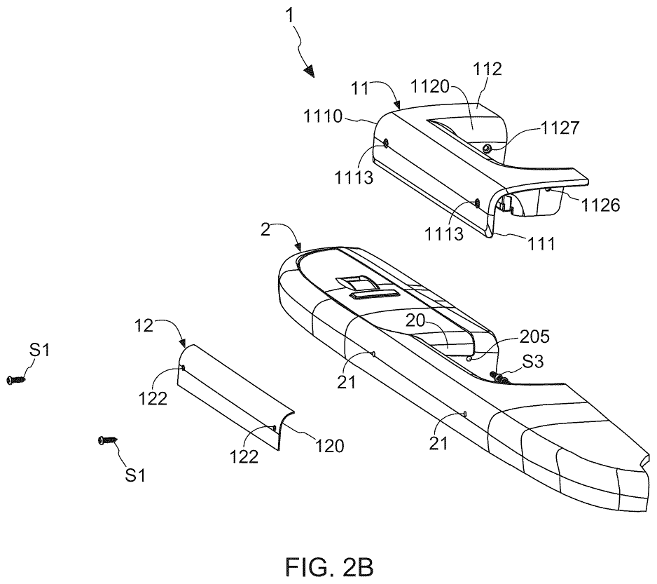

FIG. 2A and FIG. 2B illustrate a first exploded diagram and a first exploded diagram of the reinforcement device 1 according to the present invention. As FIG. 2A and FIG. 2B show, the reinforcement device 1 principally comprises a L-shaped cover member 11 and an inner plate 12, of which the L-shaped cover member 11 consists of a first plate 111 and a second plate 112. As described in more detail below, the first plate 111 covers one end side of the car door handle 2, and the second plate 112 is in connection with the first plate 111 so as to cover one surface of the car door handle 2. Moreover, it is worth noting that the first plate 111 has a first bending portion 1110, and the second plate 112 is connected to the first bending portion 1110. On the other hand, the inner plate is connected between the first plate 111 and the end side of the car door handle 2, thereby covering the end side of the car door handle 2. In one embodiment, the inner plate 12 is a metal plate, and has a second bending portion 120 mating with the first bending portion 1110.

As FIG. 2A and FIG. 2B show, the first plate 111 is formed with a shallow recess 1111 thereon, and the inner plate 12 connected between the first plate 111 and the end side of the car door handle 2 is received by the shallow recess 1111. On the other hand, the surface of the car door handle 2 has a recess structure 20, and the second plate 112 is formed with a recess thereon, such that the recess 1120 is mated with the recess structure 20 in case of the second plate 112 covering the surface of the car door handle 2. It is worth further explaining that the surface of the car door handle 2 has a first curvature, and the second plate 112 has a second curvature that approaches or is equal to the first curvature.

Moreover, FIG. 2A and FIG. 2B also depict that the end side of the car door handle 2 is formed with at least one first screw hole 21 thereon, the inner plate 12 has at least one second screw hole 122 corresponding to the at least one first screw hole 21, and the first plate 111 has at least one third screw hole 1113 corresponding to the at least one second screw hole 122. In addition, it can be noted that the recess structure 20 has first short side, a long side in connection with the first short side, and a second short side in connection with the long side, the first short side is provided with at least one fourth screw hole 204 thereon, and a fifth screw hole 205 is formed on the second short side. On the other hand, the recess 1120 is provided with at least one sixth screw hole 1126 and at least one seventh screw hole 1127 thereon, the at least one sixth screw hole 1126 is corresponding to the at least one fourth screw hole 204, and the at least one seventh screw hole 1127 is corresponding to the at least one fifth screw hole 205.

Given all the above, it should be understood that, assembling steps of the car door handle assembly shown as FIG. 1A and FIG. 1B comprises:
embedding the inner plate 12 in the shallow recess 1111 of the first plate 111, so as to make the at least one second screw hole 122 be in correspondence with the at least one third screw hole 1113;
inserting the car door handle 2 into a receiving groove formed between the first plate 111 and the second plate 112, so as to make the at least one sixth screw hole 1126 be in correspondence with the at least one fourth screw hole 204, and simultaneously make the at least one seventh screw hole 1127 be in correspondence with the at least one fifth screw hole 205;
screwing at least one first screw S1 into the at least one third screw hole 1113, the at least one second screw hole 122 and the at least one first screw hole 21 in turns;
screwing at least one second screw S2 into the at least one sixth screw hole 1126 and the at least one fourth screw hole 204 in turns; and
screwing at least one third screw S3 into the at least one seventh screw hole 1127 and the at least one fifth screw hole 205 in turns.

### Second Embodiment

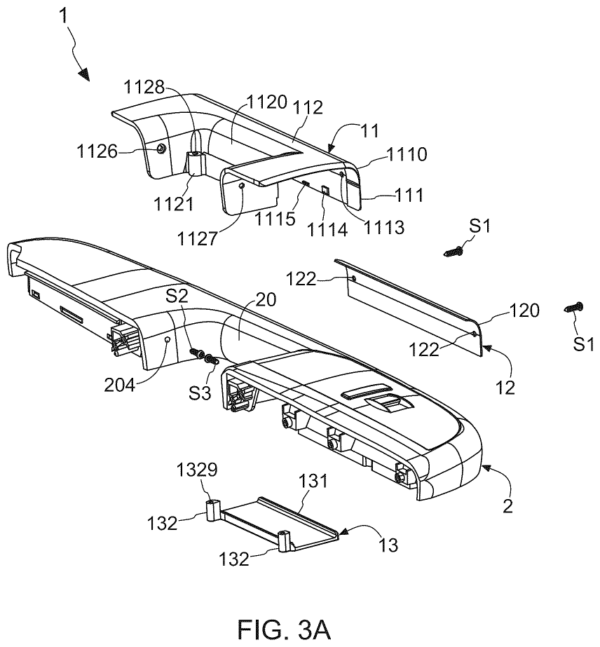

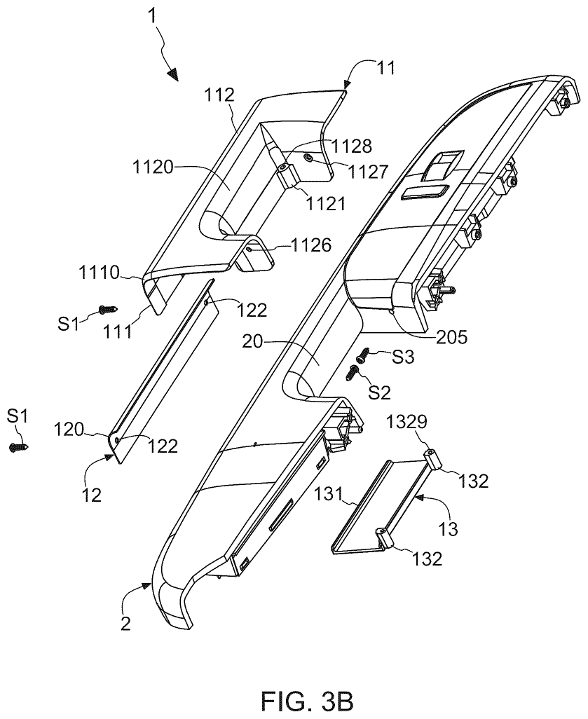

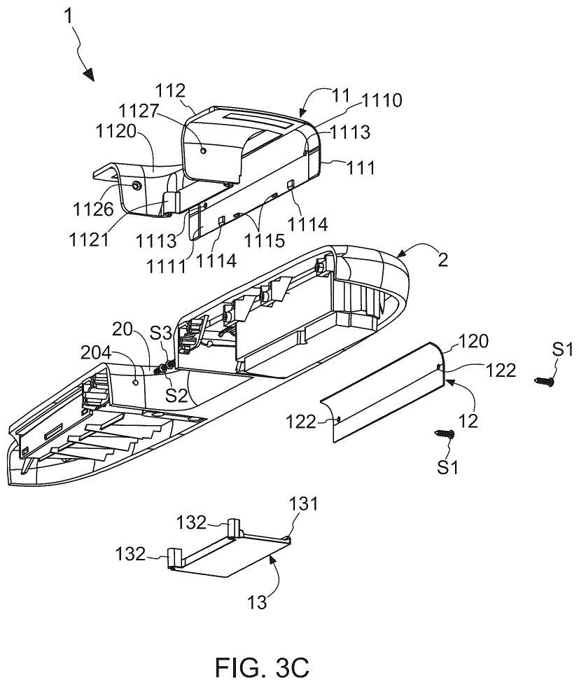

With reference to FIG. 3A, FIG. 3B and FIG. 3C, there are show a third exploded diagram, a fourth exploded diagram and a fifth exploded diagram of the reinforcement device 1 according to the present invention. As FIG. 3A, FIG. 3B and FIG. 3C show, in second embodiment the reinforcement device 1 further comprises a bottom plate 13, wherein a propping block 131 having a convex portion is formed along a first side of the bottom plate 13, and at least one connection column 132 is formed on a second side of the bottom plate 13. It is noted that a protrusion block 1115 and two limit blocks 1114 are formed in the shallow recess 1111, and the protrusion block 1115 is disposed between the two blocks 1114. Moreover, at least one ferrule 1120 is formed on the recess 1120, and the ferrule 1121 has a bottom opening.

In second embodiment, the bottom plate 13 is connected to the L-shaped cover member 11, and is limited between the two limit blocks 1114. Specifically, after the bottom plate 13 is connected to the L-shaped cover member 11, the propping block 131 sustains a lower end side of the inner plate 12, and the at least one connection column 132 received by the at least one ferrule 1120. Therefore, in case of the bottom plate 13 being limited between the two limit blocks 1114, the convex portion of the propping block 131 is propped by the protrusion block 1115.

### Third Embodiment

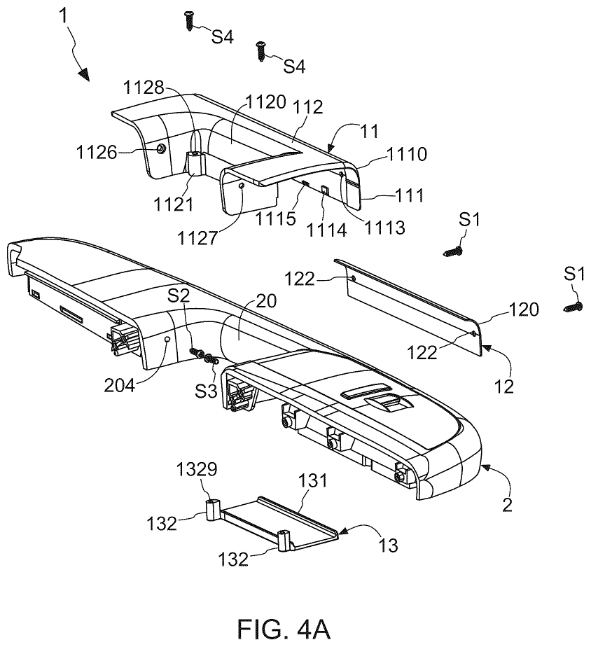

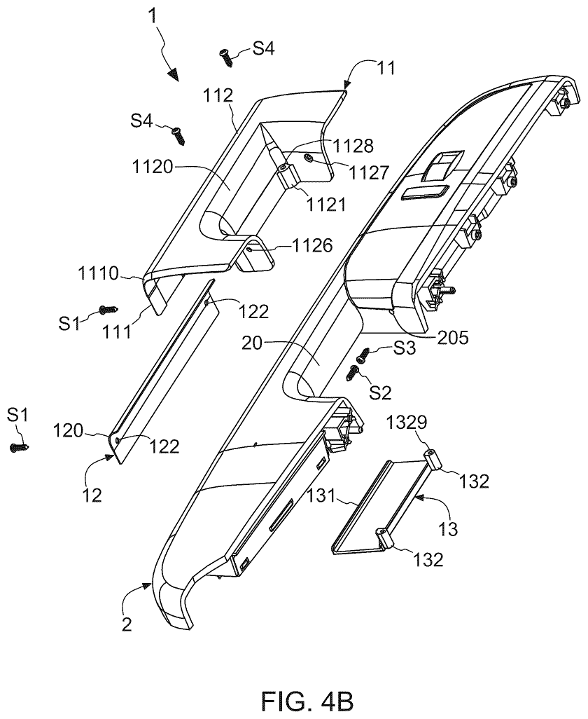

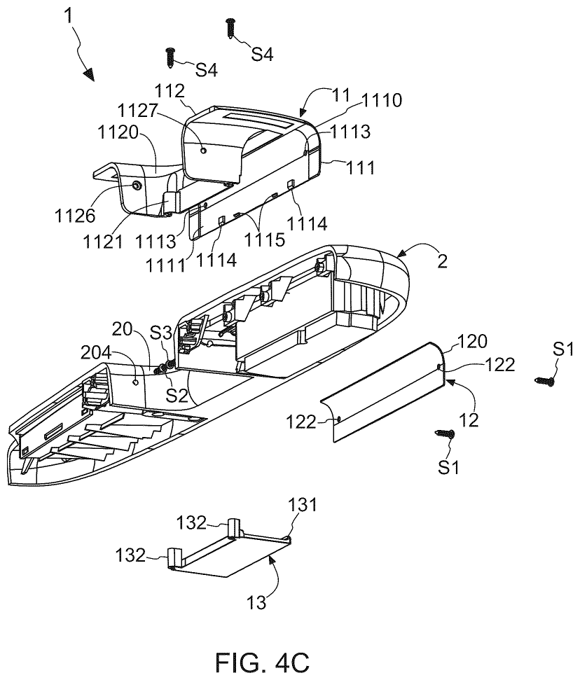

With reference to FIG. 4A, FIG. 4B and FIG. 4C, there are show a sixth exploded diagram, a seventh exploded diagram and an eighth exploded diagram of the reinforcement device 1 according to the present invention. As FIG. 4A, FIG. 4B and FIG. 4C show, in third embodiment the the ferrule 1120 is formed with an eighth screw hole 1128 therein, and a ninth screw hole 1329 is provided in the connection column 132 for being in correspondence with the eighth screw hole 1128. By such design, it is able to screw at least one fourth screw S4 into the at least one eighth screw hole 1128 and the at least one ninth screw hole 1329 in turns.

In above descriptions, the reinforcement device 1 and the car door handle assembly including the reinforcement device 1 have been introduced completely and clearly. In summary, the reinforcement device 1 according to the present invention includes following merits:
(1) reducing impact forces applied to the car door handle 2, thereby making the car door handle 2 last longer;
(2) easy to be attached to the car door handle 2 without needing to change the structure and/or constitutes of the car door handle 2; and
(3) not lead a negative effect to the appearance of the car door handle 2.

It is worth particularly explained that the above description is made on embodiments of the present invention. However, the embodiments are not intended to limit scope of the present invention, and all equivalent implementations or alterations within the spirit of the present invention still fall within the scope of the present invention.

What is claimed is:

1. A reinforcement device for being attached to a car door handle, comprising:
an L-shaped cover member, comprising:
a first plate for covering one end side of the car door handle; and
a second plate for covering one surface of the car door handle, being in connection with the first plate; and
an inner plate for covering the end side of the car door handle, being connected between the first plate and the end side of the car door handle.

2. The reinforcement device of claim 1, wherein the surface of the car door handle has a recess structure, and the second plate is formed with a recess thereon, such that the recess is mated with the recess structure in case of the second plate covering the surface of the car door handle.

3. The reinforcement device of claim 2, wherein an inner surface of the first plate is formed with a shallow recess thereon, and the inner plate connected between the first plate and the end side of the car door handle is received by the shallow recess.

4. The reinforcement device of claim 1, wherein the first plate has a first bending portion, and the second plate is connected to the first bending portion.

5. The reinforcement device of claim 4, wherein the inner plate is a metal plate, and has a second bending portion mating with the first bending portion.

6. The reinforcement device of claim 1, wherein the surface of the car door handle has a first curvature, and the second plate has a second curvature that approaches or is equal to the first curvature.

7. The reinforcement device of claim 3, wherein the end side of the car door handle is formed with at least one first screw hole thereon, the inner plate has at least one second screw hole corresponding to the at least one first screw hole, and the first plate has at least one third screw hole corresponding to the at least one second screw hole.

8. The reinforcement device of claim 7, wherein the recess structure has first short side, a long side in connection with the first short side, and a second short side in connection with the long side, the first short side is provided with at least one fourth screw hole thereon, and a fifth screw hole is formed on the second short side.

9. The reinforcement device of claim 8, wherein the recess is provided with at least one sixth screw hole and at least one seventh screw hole thereon, the at least one sixth screw hole is corresponding to the at least one fourth screw hole, and the at least one seventh screw hole is corresponding to the at least one fifth screw hole.

10. The reinforcement device of claim 9, wherein a protrusion block and two limit blocks are formed in the shallow recess, and the protrusion block is disposed between the two blocks.

11. The reinforcement device of claim 10, wherein at least one ferrule is formed on the recess, and the ferrule has a bottom opening.

12. The reinforcement device of claim 11, further comprising a bottom plate, and wherein:
a propping block is formed along a first side of the bottom plate, and has a convex portion;
at least one connection column is formed on a second side of the bottom plate;
the bottom plate is connected to the L-shaped cover member, and is limited between the two limit blocks;
after the bottom plate is connected to the L-shaped cover member, the propping block sustains a lower end side of the inner plate, and the at least one connection column received by the at least one ferrule; and
in case of the bottom plate being limited between the two limit blocks, the convex portion of the propping block is propped by the protrusion block.

13. The reinforcement device of claim 12, wherein the ferrule is formed with an eighth screw hole therein, and a ninth screw hole is provided in the connection column for being in correspondence with the eighth screw hole.

14. The reinforcement device of claim 13, further comprising:
at least one first screw for being screwed into the at least one third screw hole, the at least one second screw hole and the at least one first screw hole in turns;
at least one second screw for being screwed into the at least one sixth screw hole and the at least one fourth screw hole in turns;
at least one third screw for being screwed into the at least one seventh screw hole and the at least one fifth screw hole in turns; and
at least one fourth screw for being screwed into the at least one eighth screw hole and the at least one ninth screw hole in turns.

15. A car door handle assembly, comprising a car door handle and one said reinforcement device according to claim 1, wherein said reinforcement device is attached to the car door handle, so as to cover one surface and one end side of the car door handle.
